(19) United States
(12) Patent Application Publication
(10) Pub. No.: US 2014/0040186 A1
(43) Pub. Date: Feb. 6, 2014

(54) INFORMATION PROCESSING SYSTEM, INFORMATION PROCESSING APPARATUS AND METHOD FOR UPDATING DATA

(71) Applicant: TOSHIBA TEC KABUSHIKI KAISHA, Tokyo (JP)

(72) Inventors: Atsushi Okamura, Shizuoka-ken (JP); Hidehiko Miyakoshi, Shizuoka-ken (JP); Hiroshi Sugasawa, Miyagi-ken (JP); Hitoshi Iizaka, Shizuoka-ken (JP); Hidehiro Naito, Shizuoka-ken (JP)

(21) Appl. No.: 13/941,744

(22) Filed: Jul. 15, 2013

(30) Foreign Application Priority Data
Aug. 3, 2012 (JP) 2012-172845

(51) Int. Cl. G06F 17/27

(52) U.S. Cl. CPC G06F 17/2735
USPC 707/609

(57) ABSTRACT

An information processing system comprises a plurality of information processing apparatus and a dictionary server (server). Each of the scanners includes a local storage device, a determination module and a local update module. The server includes a master storage device, a master update module and a master transmitting module. The determination module determines the commodity category to which a commodity belongs by comparing the feature amount extracted from the image showing the appearance of the commodity with the feature amount described in a local dictionary data stored in the local storage device. The master update module updates a master dictionary data stored in the master storage device. The master transmitting module transmits the master dictionary data updated by the master update module to the scanners. The local update module updates the local dictionary data according to the master dictionary data transmitted by the transmitting module.

### CROSS-REFERENCE TO RELATED APPLICATION

This application is based upon and claims the benefit of priority from Japanese Patent Application No. P2012-172845, filed Aug. 3, 2012, the entire contents of which are incorporated herein by reference.

### FIELD

Embodiments described herein relate to an information processing system, an information processing apparatus and a method for updating data.

### BACKGROUND

An information processing apparatus, which determines which one of a plurality of commodity categories a commodity shown by an image of the appearance of the commodity belongs to by comparing the feature amount extracted from the image with the feature amount recorded in a dictionary data, is used in, for example, a POS (Point Of Sales) system to determine the categories of the commodities purchased.

The dictionary data is prepared beforehand as a data which describes the feature amount relating to the appearance of a commodity belonging to one of the commodity categories to which commodities that a store deals in belongs, and is provided in each information processing apparatus.

The commodity category refers to a category required to distinguish commodities for the sales management. That is, if apples can be distinguished from other commodities without distinguishing variety of apples, then, ‘apple’ becomes one of the commodity categories. However, if it is necessary to distinguish the variety of apples, ‘Apple (Fuji)’ or ‘Apple (Golden Delicious)’ and the like respectively become each of the commodity categories. Thus, the term ‘commodity category’, used herein, specifically refers to one of the two different meanings or definitions according to various circumstances in sales management aspect.

### BRIEF DESCRIPTION OF THE DRAWINGS

FIG. 1 is a block diagram illustrating a POS system according to an embodiment;

FIG. 2 is a diagram illustrating the structure of a dictionary data;

FIG. 3 is a block diagram illustrating a POS terminal shown in FIG. 1;

FIG. 4 is a flowchart of a dictionary synchronization processing;

FIG. 5 is a flowchart of a pull-synchronization processing;

FIG. 6 is a flowchart of a push-synchronization processing;

FIG. 7 is a diagram illustrating an example of a modification of the POS system; and

FIG. 8 is a diagram illustrating another example of the modification of the POS system.

### DETAILED DESCRIPTION

In accordance with one embodiment, an information processing system includes a plurality of information processing apparatus and a dictionary server. Each of the information processing apparatus includes a local storage device, a determination module and a local update module. The dictionary server includes a master storage device, a master update module and a master transmitting module. The local storage device stores a local dictionary data which describes a feature amount relating to the appearance of a commodity belonging to one of a plurality of commodity categories. The determination module determines the category of the commodity shown by an image by comparing the feature amount extracted from the image showing the appearance of the commodity with the feature amount described in the local dictionary data. The master storage device stores a master dictionary data which describes the feature amount relating to the appearance of a commodity belonging to one of the plurality of commodity categories. The master update module updates the master dictionary data. The master transmitting module transmits the master dictionary data updated by the master update module to an information processing apparatus. The local update module updates the local dictionary data according to the master dictionary data transmitted by the master transmitting module.

An example of the embodiment is described below with reference to the accompanying drawings. In the present embodiment, a POS system (information processing system) comprising a plurality of POS terminals (information processing apparatus) each having the function of an object recognition.

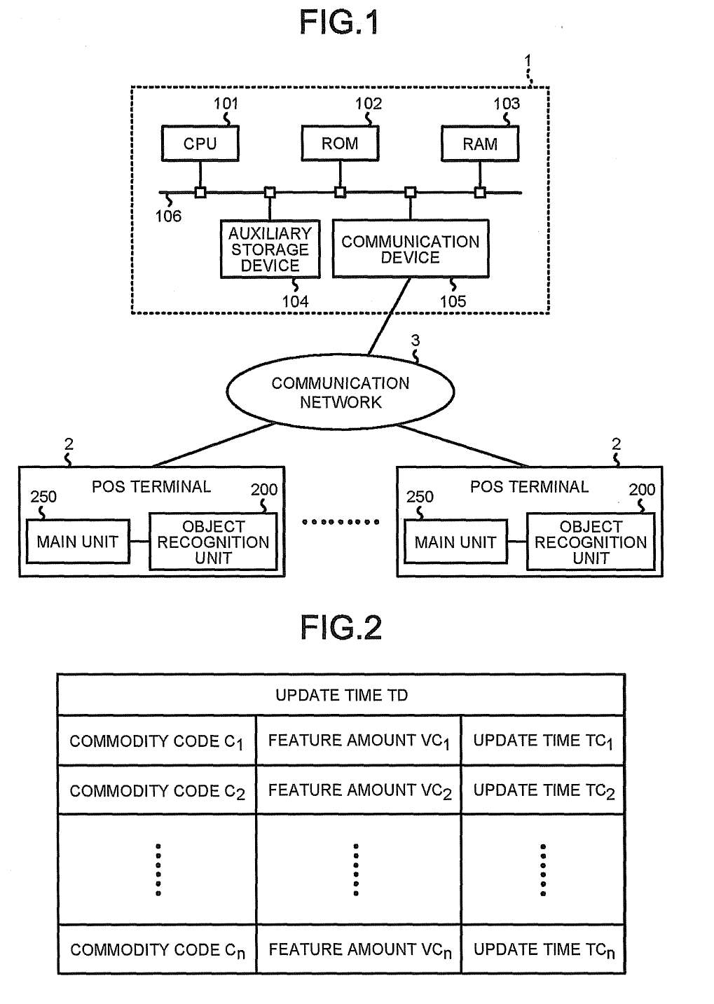

FIG. 1 is a block diagram of a POS system according to the present embodiment.

The POS system shown in FIG. 1 includes a dictionary server 1 and a plurality of POS terminals 2. Moreover, the dictionary server 1 is able to communicate with each of the plurality of POS terminals 2 via a communication network 3.

The dictionary server 1 manages a dictionary data used in the POS terminal 2 to determine a commodity category to which a purchased commodity belongs. The POS terminal 2 carries out various data processing concerning commodity sales, such as a registration of commodities purchased, a calculation and settlement of a purchased amount or a point processing.

The dictionary server 1 includes a CPU (central processing unit) 101, a ROM (read only memory) 102, a RAM (random access memory) 103, an auxiliary storage device 104 and a communication device 105.

Moreover, the CPU 101, the ROM 102, the RAM 103, the auxiliary storage device 104 and the communication device 105 are connected with a bus line 106, respectively.

The CPU 101 carries out a processing for managing the dictionary data according to the operating system and the application programs stored in the ROM 102 and the RAM 103.

The ROM 102 stores the aforementioned operating system. In some conditions, the ROM 102 stores the aforementioned application programs, as well and the ROM 102 also stores data referred to when CPU 101 carries out various processing.

The RAM 103 stores the data referred to by the CPU 101 when the CPU carries out various processing. Further, the RAM 103 is used as a so-called work area for storing data which is temporarily used when the CPU 101 carries out various processing.

The auxiliary storage device 104, which is, for example, an HDD (hard disc drive) or a SSD (Solid State Drive), stores data that is used by the CPU 101 when the CPU 101 carries out various processing and, data that is generated in the processing of the CPU 101. The data stored in the auxiliary storage device 104 includes a dictionary data. Further, the dictionary data stored in the auxiliary storage device 104 is referred hereinafter to as a master dictionary data. Thus, the auxiliary storage device 104 has a function of a master storage device. The auxiliary storage device 104 may store the aforementioned application programs occasionally.

The communication device 105, which communicates with the POS terminal 2 via the communication network 3, can be, for example, an existing LAN communication device or Internet communication device.

The application programs stored in the ROM 102 or the auxiliary storage device 104 include a dictionary server program which describes a dictionary synchronous processing described later. In a case in which the dictionary server application program is stored in the auxiliary storage device 104, the dictionary server 1 is generally transferred in a state that the dictionary server program is stored in the auxiliary storage device 104. However, the dictionary server 1 may be transferred without the dictionary server program. The dictionary server program is recorded in a removable recording medium such as a magnetic disc, a magnetic optical disc, an optical disc or a semiconductor memory, or transferred via a network, and the dictionary server program is written into the auxiliary storage device 104 of the dictionary server 1 which is separately transferred as described above.

The dictionary server 1 may use a general purpose server apparatus or a computer apparatus as a basic hardware. The auxiliary storage device 104 and the communication device 105 may respectively use general purpose devices which are externally connected to the general purpose server apparatus or computer apparatus. If a general purpose device is used as at least one of the auxiliary storage device 104 and the communication device 105, the dictionary server 1 may be realized without including the device.

FIG. 2 is a diagram illustrating the structure of the dictionary data.

As shown in FIG. 2, the dictionary data includes one update time TD and a plurality of data records in which a commodity code C (C1, C2, . . . Cn), a feature amount VC (VC1, VC2, . . . VCn) and an update time TC (T1, T2, . . . Tn) are described in association with each other. Further, n is any integer, which is changeable because the number of the data records contained in the dictionary data is changeable.

The update time TD represents the latest update timing of the dictionary data.

The commodity code C is identification information for identifying each commodity category. The feature amount VC is a feature amount relating to the appearance of a commodity belonging to the commodity category identified by an associated commodity code C. Further, in general, the feature amount VC includes a plurality of values, and the number of the values included in one feature amount VC is changeable. The update time TC represents the latest update timing of an associated feature amount VC.

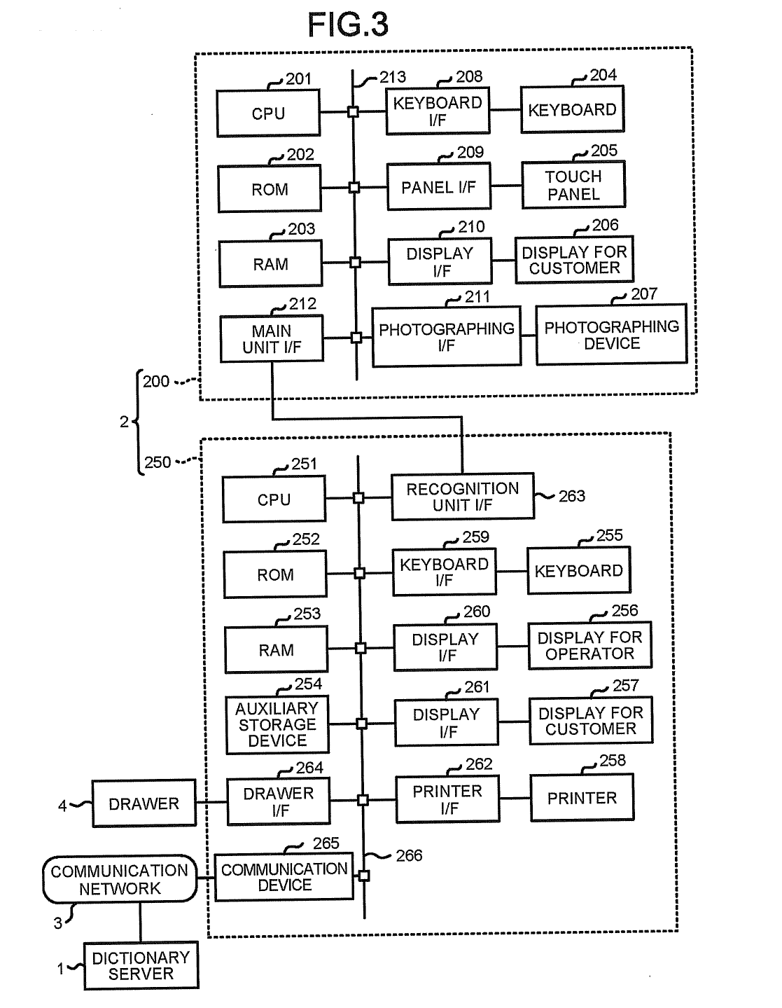

FIG. 3 is a block diagram of the POS terminal 2. As shown in FIG. 1 and FIG. 3, the POS terminal 2 includes an object recognition unit 200 and a main unit 250.

The object recognition unit 200 includes a CPU 201, a ROM 202, a RAM 203, a keyboard 204, a touch panel 205, a display for customer 206, a photographing device 207, a keyboard interface (keyboard I/F) 208, a panel interface (panel I/F) 209, a display interface (display I/F) 210, a photographing interface (photographing I/F) 211, a main unit interface (main unit I/F) 212 and a bus line 213. The bus line 213 includes an address bus line and a data bus line and the like, which connects the CPU 201, the ROM 202, the RAM 203, the keyboard interface 208, the panel interfaces 209, the display interface 210, the photographing interface 211 and the main unit interface 212 with each other.

The CPU 201 controls each component of the object recognition unit 200 to realize each operation of the object recognition unit 200 according to the operating system and application program stored in the ROM 202 and the RAM 203.

The ROM 202 stores the aforementioned operating system, and may store the aforementioned application program as well. Besides, the ROM 202 may also store data which is referred to by the CPU 201 which carries out various processing.

The RAM 203 stores data which is referred to by the CPU 201 which carries out various processing. Further, the RAM 203 is used as a so-called work area which stores data temporarily used by the CPU 201 which carries out various processing.

The keyboard 204 includes a plurality of key switches and outputs commands indicating content of the operation by an operator through the key switches.

The touch panel 205 includes, for example, a display device such as an LCD (liquid crystal display) and a transparent two-dimensional touch sensor overlaid on the display screen of the display device. The touch panel 205 displays any image on the display device under the control of the CPU 201. The touch panel 205 detects the touch position of the operator on the display screen of the display device with the two-dimensional touch sensor to output a coordinate data representing the touch position. The touch panel 205 is used to display images representing various kinds of information that should be prompted to the operator and to input the operation of the operator.

The display for customer 206 displays any character string or image under the control of the CPU 201. The display for customer 206 is utilized for displaying various character strings or images that should be prompted to a customer. The display for customer 206 can be, for example, a fluorescent tube display or an LCD.

The photographing device 207 includes an area image sensor and a drive circuit thereof. The area image sensor is, for example, a CCD (charge coupled device) photographing device. The photographing device 207 acquires, at given time intervals, frame data representing the image (frame image) of a specific photographed area outside the object recognition unit 200 and outputs the frame data.

The keyboard interface 208, which carries out the data transmission/reception between the keyboard 204 and the CPU 201, is, for example, a well-known device in accordance with the PS/2 standard or the USB (universal serial bus) standard.

The panel interface 209, which carries out the data and image signal transmission/reception between the touch panel 205 and the CPU 201, includes an interface for a display device and an interface for a touch sensor. The interface for a display device is, for example, a well-known device in accordance with the VGA (video graphics array) standard (analog RGB standard), the DVI (digital video interface) standard or the LVDS (low voltage differential signaling) standard. The interface for a touch sensor is, for example, a well-known device in accordance with the USE standard or the RS-232C (recommended standard) standard.

The display interface 210, which carries out the image signal transmission/reception between the display for customer 206 and the CPU 201, may be a well-known device in accordance with the USB standard or the RS-232C standard if the display for customer 206 is a fluorescent tube display, or a well-known device in accordance with the VGA, DVI or LVDS standard if the display for customer 206 is an LCD.

The photographing interface 211, which carries out the data transmission/reception between the photographing device 207 and the CPU 201, may be, for example, a well-known device in accordance with the USB or IEEE (institute of electrical and electronic engineers) 1394 standard.

The main unit interface 212, which executes the data transmission/reception between the main unit 250 and the CPU 201, may be, for example, a well-known device in accordance with the USB standard or the RS-232C (recommended standard) standard.

The main unit 250 includes a CPU 251, a ROM 252, a RAM 253, an auxiliary storage device 254, a keyboard 255, a display for operator 256, a display for customer 257, a printer 258, a keyboard interface (keyboard I/F) 259, a display interfaces (display I/F) 260 and 261, a printer interface (printer I/F) 262, a recognition unit interface (recognition unit I/F) 263, drawer interface (drawer I/F) 264, a communication device 265 and a bus line 266. Further, the bus line 266, which includes an address bus and a data bus, connects the CPU 251, the ROM 252, the RAM 253, the auxiliary storage device 254, the keyboard interface 259, the display interfaces 260 and 261, the printer interface 262, the recognition unit interface 263, the drawer interface 264 and the communication device 265 with each other.

The CPU 251 controls each section to realize each operation of the main unit 250 according to the operating system and application program stored in the ROM 252 and the RAM 253.

The ROM 252 stores the aforementioned operating system. The ROM 252 may store the application program as well. Besides, the ROM 252 may also store data which is referred to by the CPU 251 which carries out various processing.

The RAM 253 stores data which is referred to by the CPU 251 which carries out various processing. Further, the RAM 253 is used as a so-called work area for storing data that is temporarily used when the CPU 251 carries out various processing. A part of the storage area of the RAM 253 serves as a commodity list area for managing information of the commodities which are purchased and registered.

The auxiliary storage device 254, which is, for example, an HDD (hard disc drive) or a SSD (solid state drive), stores data used by the CPU 251 which carries out various processing and data generated in the processing of the CPU 251. The auxiliary storage device 254 may store the dictionary data used by the object recognition unit 200. In this case, the CPU 201 may refer to the dictionary data stored in the auxiliary storage device 254 via the main unit interface 212 and the recognition unit interface 263 or copy the dictionary data stored in the auxiliary storage device 254 into the RAM 203 when the object recognition unit 200 is started.

The application programs stored in the ROM 252 or auxiliary storage device 254 include a control program which describes a processing described later. The POS terminal 2 or main unit 250 is generally transferred in a state that the control program is stored in the ROM 252 or auxiliary storage device 254. However, the POS terminal 2 or main unit 250 may be transferred without the control program. The control program is stored in a removable recording medium, such as, a magnetic disc, a magnetic optical disc, an optical disc or a semiconductor memory or transferred via a network, and the control program is written into the ROM 252 or the auxiliary storage device 254 of the POS terminal 2 or the main unit 250 which is separately transferred as described above.

The keyboard 255 includes a plurality of key switches to output commands representing contents of operation by an operator through the key switches.

The display for operator 256 displays any image under the control of the CPU 251. The display for operator 256 is utilized for displaying various images that should be prompted to the operator and may be an LCD.

The display for customer 257 displays any character string or image under the control of the CPU 251. The display for customer 257 displays various character strings or images that should be prompted to a customer. The display for customer 257 is, for example, a fluorescent tube display or an LCD.

The printer 258 prints a receipt image indicating the content of one transaction on a receipt paper under the control of the CPU 251. The printer 258 may be any well-known existing available printer. Typically, the printer 258 is a thermal printer.

The keyboard interface 259, which carries out the data transmission/reception between the keyboard 255 and the CPU 251, may be, for example, a well-known device in accordance with the PS/2 or USB standard.

The display interface 260, which carries out the image signal transmission/reception between the display for operator 256 and the CPU 201, may be, for example, a well-known device in accordance with the VGA, DVI or LVDS standard.

The display interface 261, which carries out the image signal transmission/reception between the display for customer 257 and the CPU 251, may be a well-known device in accordance with the USB or RS-232C standard if the display for customer 257 is a fluorescent tube display, or a well-known device in accordance with the VGA, DVI or LVDS standard if the display for customer 257 is an LCD.

The printer interface 262, which carries out the data transmission/reception between the printer 258 and the CPU 251, may be, for example, a well-known device in accordance with the USB, RS-232C or IEEE1284 standard (so-called Centronics spec.).

The recognition unit interface 263, which carries out the data transmission/reception between the object recognition unit 200 and the CPU 251, may be, for example, a well-known device in accordance with the standard that the main unit interface 212 follows.

The drawer interface 264 outputs a drive signal for opening a drawer 4 in response to an instruction of opening the drawer from the CPU 251.

The communication device 265 communicates with the dictionary server 1 via the communication network 3. The communication device 265 may be, for example, an existing LAN communication device.

Next, the operation of the POS system with the structure above is described below. The functions which are achieved by an existing POS terminal, such as a function of determining category of the commodity purchased or a function of registering the commodity purchased, are also achieved by the POS terminal 2 and are therefore not described herein. The management processing on the dictionary data used by the object recognition unit 200 for determining a commodity category is described here in detail.

A description is made on the premises that all local dictionary data is stored in the auxiliary storage device 254, and the local dictionary data stored in the auxiliary storage device 254 is partially or wholly copied into the RAM 203 as needed.

The CPU 201 carries out a well-known processing on the frame data output by the photographing device 207 and compares the feature amount extracted from an image showing the appearance of a commodity with the feature amount described in the local dictionary data to determine which one of a plurality of commodity categories the commodity shown by the image belongs to. When the determination is made, the CPU 201 refers to the local dictionary data copied to the RAM 203 or the local dictionary data stored in the auxiliary storage device 254 appropriately.

In this way, the auxiliary storage device 254 functions as a local storage device. Further, the CPU 201 functions as a determination module.

It is assumed that the CPU 201 executes a learning processing relating to the local dictionary data. The learning processing may be the well-known processing, but the CPU 201 updates the local dictionary data stored in the RAM 203. Further, for example, the CPU 201 frequently notifies the CPU 251 of the learning content at a preset given timing such as a timing that a series of processing for one customer is ended.

Upon receiving the notice, the CPU 251 updates the local dictionary data stored in the auxiliary storage device 254 to reflect the learning content of the local dictionary data stored in the RAM 203. Further, like the master dictionary data, the local dictionary data describes various kinds of information with the structure shown in FIG. 2. In this way, the function of a learning module is achieved through the cooperation of the CPU 201 and the CPU 251. The learning processing may be executed by the CPU 251 exclusively.

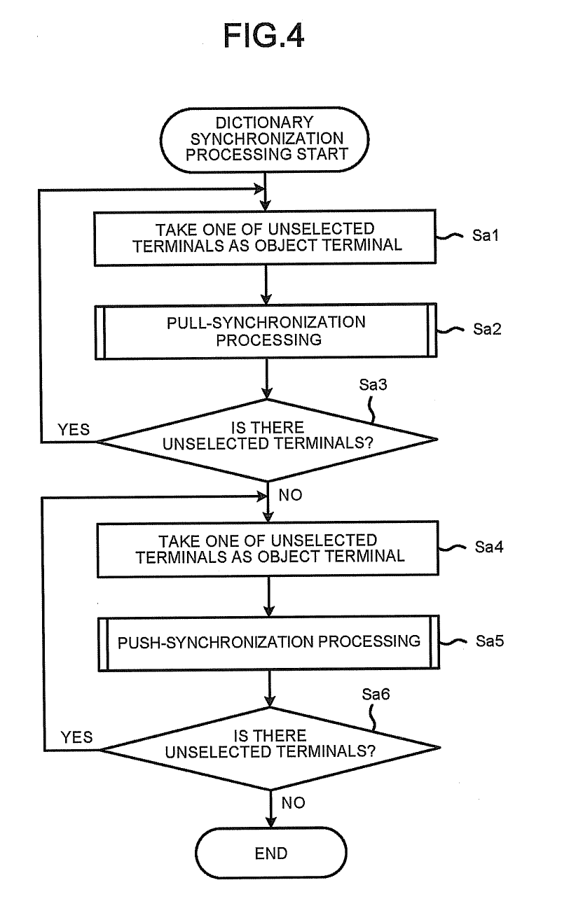

If the preset synchronous starting timing comes, then the CPU 101 executes the dictionary synchronous processing shown in FIG. 4 according to a dictionary server program. In addition, it is assumed that the synchronization starting timing is preset, and is typically assumed to be the closing timing of a registration operation or the closing time of a shop.

In ACT Sa1, the CPU 101 selects, as an object terminal of a pull-synchronization processing in a plurality of POS terminals 2, one of the POS terminals 2 which are not yet selected in the current dictionary synchronization processing.

In ACT Sa2, the CPU 101 executes a pull-synchronization processing on the object terminal selected in ACT Sa1.

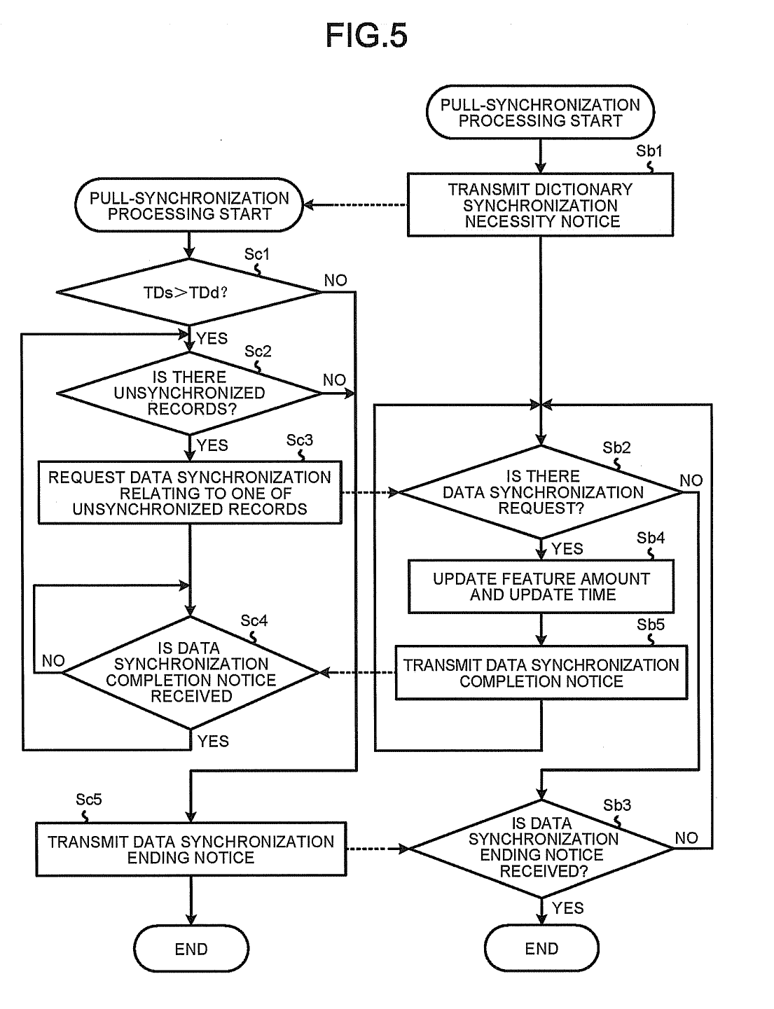

FIG. 5 is a flowchart of a pull-synchronization processing. The flowchart shown at the left side in FIG. 5 illustrates the processing procedures of the CPU 251 in the POS terminal 2 selected as an object terminal, and that shown at the right side in FIG. 5 illustrates the processing procedures of the CPU 101.

In ACT Sb1, the CPU 101 transmits a dictionary synchronization necessity notice to the object terminal from the communication device 105 via the communication network 3. Further, the CPU 101 adds the update time TD included in the master dictionary data to the dictionary synchronization necessity notice as a synchronization target update time TDd.

In the POS terminal 2 serving as the object terminal, the communication device 265 receives the dictionary synchronization necessity notice via the communication network 3 to store it in the RAM 253 and notifies the reception of the dictionary synchronization necessity notice to the CPU 251. Upon receiving the notice, the CPU 251 starts the pull-synchronization processing shown in FIG. 5.

In ACT Sc1, the CPU 251 takes the update time TD included in the local dictionary data stored in the RAM 253 as a synchronization source update time TDs to determine whether or not the following relationship is met: TDs>TDd. That is, the CPU 251 confirms whether or not the synchronization source update time TDs equivalent to the latest update time of the local dictionary data is more recent or newer than the synchronization target update time TDd equivalent to the latest update time of the master dictionary data. If the relationship is met, that is, the result of the determination is “YES” because the latest update time of the local dictionary data is newer than the latest update time of the master dictionary data, then the CPU 251 proceeds to ACT Sc2. In this way, the CPU 251 confirms whether or not the master dictionary data is different from the local dictionary data by comparing the time TDs serving as a fourth timing information with the time TDd serving as a fifth timing information, thereby functioning as a third confirmation module.

In ACT Sc2, the CPU 251 confirms whether or not there is a synchronization object record which is not synchronized in the current synchronization processing (hereinafter referred to as an unsynchronized record) in the data records included in the master dictionary data. In a case that an update time TC associated with a commodity code C in the master dictionary data serves as a synchronization target update time TCs, if the following relationship is met: TCs>TDd, then a data record including the commodity code C is a synchronization object record. Moreover, if the result of the determination is ‘Yes’ because there is an unsynchronized record, then the CPU 251 proceeds to ACT Sc3. In this way, the CPU 251 confirms whether or not the data records relating to the same commodity code respectively included in the master dictionary data and the local dictionary data are different from each other by comparing the time TCs serving as a sixth timing information with the time TDd serving as the fifth timing information, thereby functioning as a fourth confirmation module.

In ACT Sc3, the CPU 251 selects one of unsynchronized records and transmits a data synchronization request relating to the unsynchronized record to the dictionary server 1 from the communication device 265 via the communication network 3. At this time, the CPU 251 adds the various information (e.g. feature amount and update time and the like) of the data record in the local dictionary data including the commodity code C included in the selected unsynchronized record to the data synchronization request. In this way, the CPU 251 functions as a local transmitting module.

Then, the CPU 101 moves to the processing in ACT Sb2 after transmitting a dictionary synchronization necessity notice in ACT Sb1.

In ACT Sb2, the CPU 101 confirms whether or not the data synchronization request transmitted from the object terminal is received. If the result of the determination is ‘No’ because the data synchronization request is not received, the CPU 101 proceeds to ACT Sb3.

In ACT Sb3, the CPU 101 confirms whether or not a data synchronization ending notice transmitted from the object terminal described later is received. If the result of the determination is ‘No’ because the data synchronization ending notice is not received, the CPU 101 returns to ACT Sb2.

In this way, the CPU 101 waits for the reception of the data synchronization request or the data synchronization ending notice in ACT Sb2 and ACT Sb3.

Sequentially, in the dictionary server 1, the communication device 105 receives the data synchronization request via the communication network 3 to store the data synchronization request in the RAM 103 and notifies the reception of the notice to the CPU 101. If the CPU 101 receives this notice while the CPU 101 is in the standby state in ACTs Sb2 or Sb3, the CPU 101 determines that the result of the determination in ACT Sb2 is ‘Yes’ and then proceeds to ACT Sb4.

In ACT Sb4, the CPU 101 updates the feature amount VC and the update time TC which are associated with the commodity code C included in the data synchronization request in the master dictionary data to the feature amount VC and the update time TC included in the data synchronization request. In this way, the CPU 101 functions as a master update module.

In ACT Sb5, the CPU 101 transmits a data synchronization completion notice to the object terminal from the communication device 105 via the communication network 3. After that, the CPU 101 returns to the standby state in ACT Sb2 or ACT Sb3.

The CPU 251 moves to ACT Sc4 after transmitting the data synchronization request in ACT Sc3.

In ACT Sc4, the CPU 251 confirms whether or not the data synchronization completion notice is received. If the result of the determination is ‘No’ because the data synchronization completion notice is not received, the CPU 101 returns to ACT Sc4. The CPU 251 waits for the reception of the data synchronization completion notice in ACT Sc4.

On the other hand, if the data synchronization completion notice is transmitted to the object terminal through the communication network 3, then the communication device 265 receives the data synchronization completion notice to store it in the RAM 253 and notifies the reception of the notice to the CPU 251. Then, the CPU 251 determines that the result of the determination in ACT Sc4 is ‘Yes’ and returns to ACT Sc2. If there is one or more unsynchronized records in ACT Sc2, then the CPU 251 repeats ACT Sc3 and ACT Sc4 by taking one of the unsynchronized records as the object subject to the processing. If there are no unsynchronized records, then the CPU 251 determines that the result of the determination in ACT Sc2 is ‘No’ and proceeds to ACT Sc5. If the following relationship is not met: TDs>TDd, and thus the result of the determination in ACT Sc1 is determined to be ‘No’, then the CPU 251 proceeds to ACT Sc5 without executing the processing in ACT Sc2-ACT Sc4.

In ACT Sc5, the CPU 251 transmits the data synchronization ending notice to the dictionary server 1 from the communication device 265 via the communication network 3. Then, the CPU 251 completes the current pull-synchronization processing.

In the dictionary server 1, the communication device 105 receives the data synchronization ending notice via the communication network 3 to store it in the RAM 103 and notifies the reception of the notice to the CPU 101. If the CPU 101 receives this notice while it is in the standby state described in ACT Sb2 and Sb3, the CPU 101 determines that the result of the determination in ACT Sb3 is ‘Yes’, and then completes the current pull-synchronization processing.

As described above, the CPU 101 proceeds to ACT Sa3 from ACT Sa2 shown in FIG. 4 if the pull-synchronization processing is completed.

In ACT Sa3, the CPU 101 confirms whether or not there is one or more unselected terminals. If the result of the determination is ‘Yes’ because there is one or more unselected terminals, the CPU 101 repeats the processing in ACT Sa1 and ACT Sa2. That is, the CPU 101 carries out the pull-synchronization processing by successively taking one of the unselected terminals as an object terminal subject to the processing. If the result of the determination in ACT Sa3 is ‘No’ because the pull-synchronization processing is carried out to all the plurality of POS terminals 2 and there is no unselected terminal, then the CPU 101 proceeds to ACT Sa4. In this way, the CPU 101 updates the master dictionary data to a content that the learning result on the local dictionary data in the plurality of POS terminals 2 is taken into consideration and then proceeds to ACT Sa4.

In ACT Sa4, the CPU 101 selects, as an object terminal of the push-synchronization processing in a plurality of POS terminals 2, one of the POS terminals 2 which are not yet selected in the current dictionary synchronization processing.

In ACT Say, the CPU 101 executes the push-synchronization processing on the object terminal selected in ACT Sa4.

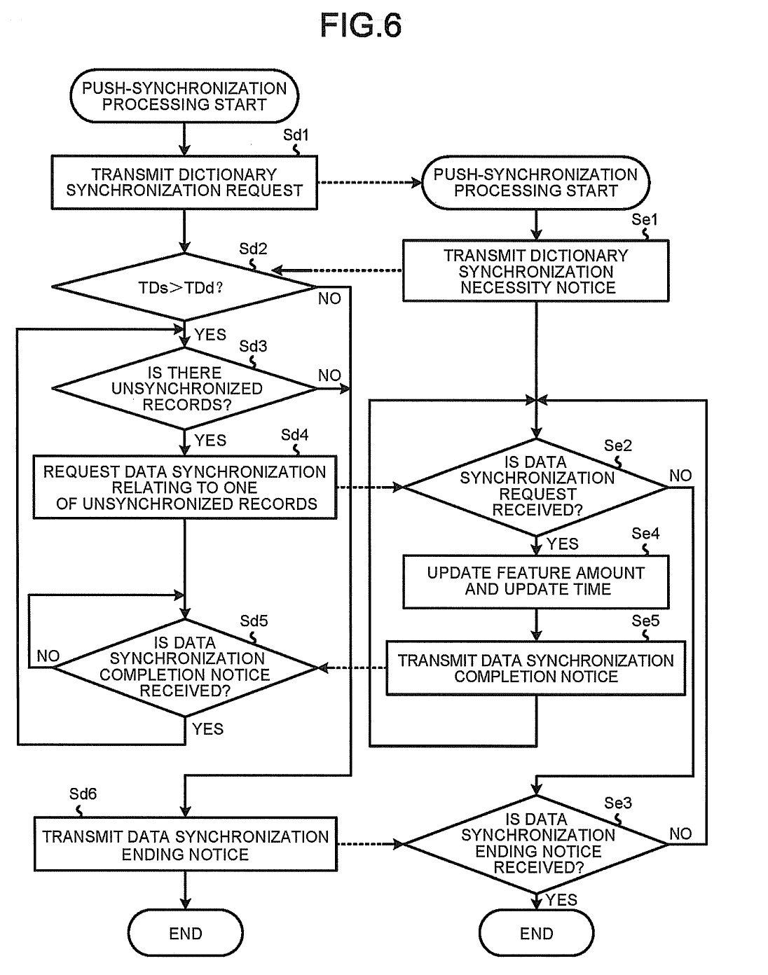

FIG. 6 is a flowchart of the push-synchronization processing. The flowchart shown at the left side in FIG. 6 illustrates the processing procedures of the CPU 101, and that shown at the right side in FIG. 6 illustrates the processing procedures of the CPU 251 of a POS terminal 2 selected as an object terminal.

In ACT Sd1, the CPU 101 transmits a dictionary synchronization request to the object terminal from the communication device 105 via the communication network 3. The CPU 101 may add the update time TD included in the master dictionary data to the dictionary synchronization request as a synchronization source update time TDs.

In the POS terminal 2 serving as an object terminal, the communication device 265 receives the dictionary synchronization request via the communication network 3 to store the request in the RAM 253 and notifies the reception of the request to the CPU 251. When the CPU 251 receives the notice, then the CPU 251 starts the push-synchronization processing shown in FIG. 6.

In ACT Se1, the CPU 251 transmits a dictionary synchronization necessity notice to the object terminal from the communication device 265 via the communication network 3. The CPU 251 adds the update time TD included in the local dictionary data stored in the auxiliary storage device 254 to the dictionary synchronization necessity notice as a synchronization target update time TDd.

In the dictionary server 1, the communication device 105 receives the dictionary synchronization necessity notice via the communication network 3 to store the notice in the RAM 103 and notifies the reception of the notice to the CPU 101. When the CPU 101 receives the notice, then the CPU 101 proceeds to ACT Sd2.

In ACT Sd2, the CPU 101 confirms whether or not the following relationship is met: TDs>TDd. That is, the CPU 101 confirms whether or not the synchronization source update time TDs equivalent to the latest update time of the master dictionary data is newer than the synchronization target update time TDd equivalent to the latest update time of the local dictionary data. If the relationship is met, the result of the determination is ‘Yes’. That is, the latest update time of the master dictionary data is newer than the latest update time of the local dictionary data. Then, the CPU 251 proceeds to ACT Sd3. In this way, the CPU 101 confirms whether or not the master dictionary data is different from the local dictionary data by comparing the time TDs serving as the first timing information with the time TDd serving as the third timing information, thereby functioning as the first confirmation module.

In ACT Sd3, the CPU 101 confirms whether or not there is a synchronization object record which is not synchronized in the current synchronization processing (hereinafter referred to as an unsynchronized record) in the data records included in the master dictionary data. In a case in which the update time TC associated with a commodity code C in the master dictionary data serves as a synchronization target update time TCs, if the following relationship is met: TCs>TDd, then the data record including the commodity code C is a synchronization object record. If the result of the determination is ‘Yes’ because there is one or more unsynchronized records, then the CPU 101 proceeds to ACT Sd4. In this way, the CPU 101 confirms whether or not the data records relating to the same commodity code C included in the master dictionary data and the local dictionary data respectively are different from each other by comparing the time TCs serving as the second timing information with the time TDd serving as the third timing information, thereby functioning as the second confirmation module.

In ACT Sd4, the CPU 101 selects one of the unsynchronized records and transmits a data synchronization request relating to the unsynchronized record to the dictionary server 1 from the communication device 265 via the communication network 3. The CPU 101 adds the various information of the data record in the master dictionary data including the commodity code C included in the selected unsynchronized record to the data synchronization request. In this way, the CPU 101 functions as a master transmitting module.

Then, the CPU 251 moves to the processing in ACT Se2 after transmitting the dictionary synchronization necessity notice in ACT Se1.

In ACT Se2, the CPU 251 confirms whether or not the data synchronization request transmitted from the object terminal is received. If the data synchronization request is not received and then the result of the determination is ‘No’, then the CPU 251 proceeds to ACT Se3.

In ACT Se3, the CPU 251 confirms whether or not a data synchronization ending notice transmitted by the object terminal as described later is received. If the data synchronization ending notice is not received and then the result of the determination is ‘No’, then the CPU 251 returns to ACT Se2.

In this way, the CPU 251 waits for the data synchronization request or the data synchronization ending notice in ACT Se2 or ACT Se3.

In the POS terminal 2 serving as an object terminal, the communication device 265 receives the data synchronization request via the communication network 3 to store the request in the RAM 253 and notifies the reception of the request to the CPU 101. If the CPU 101 receives this notice while it is in the standby state in ACTs Se2 and Se3, the CPU 251 determines that the result of the determination in ACT Se2 is ‘Yes’ and then proceeds to ACT Se4.

In ACT Se4, the CPU 251 updates the feature amount VC and the update time TC associated with the commodity code C included in the data synchronization request in the local dictionary data such that the feature amount VC and the update time TC in the local dictionary data are rewritten into the feature amount VC and update time TC included in the data synchronization request. In this way, the CPU 251 functions as a local update module.

In ACT Se5, the CPU 251 transmits the data synchronization completion notice to the dictionary server 1 from the communication device 265 via the communication network 3. After that, the CPU 251 returns to the standby state in ACT Se2 and ACT Se3.

The CPU 101 moves to the processing in ACT Sd5 after transmitting the data synchronization request in ACT Sd4.

In ACT Sd5, the CPU 101 confirms whether or not the data synchronization completion notice is received. If the data synchronization completion notice is not received and thus the result of the determination is ‘No’, the CPU 101 returns to ACT Sd5. That is, the CPU 101 waits for the reception of the data synchronization completion notice in ACT Sd5.

On the other hand, if the data synchronization completion notice sent to the dictionary server 1 through the communication network 3 is received by the communication device 105 and is stored in the RAM 103. Then, the reception of the notice is notified to the CPU 101. Upon reception of the notification, the CPU 101 determines that the result of the determination in ACT Sd5 is ‘Yes’ and returns to ACT Sd3. If there is one or more unsynchronized records, the CPU 101 repeats the processing in ACT Sd4 and ACT Sd5 on one of the unsynchronized records as an object. When unsynchronized records become zero, then the CPU 101 determines that the result of the determination in ACT Sd3 is ‘No’ and proceeds to ACT Sd6. Besides, if the result of the determination in ACT Sd2 is ‘No’ because the following relationship is not met: TDs>TDd, then the CPU 101 proceeds to ACT Sd6 without executing the processing in ACT Sd3-ACT Sd5.

In ACT Sd6, the CPU 101 transmits the data synchronization ending notice to the object terminal from the communication device 105 via the communication network 3. And then, the CPU 101 completes the current push-synchronization processing.

In the POS terminal 2 serving as an object terminal, the communication device 265 receives the data synchronization ending notice via the communication network 3 to store the notice in the RAM 253 and notifies the reception of the notice to the CPU 251. When the CPU 251 receives this notification while it is in the standby state in ACTs Se2 and Se3, the CPU 251 determines that the result of the determination in ACT Se3 is ‘Yes’ and then completes the current push-synchronization processing.

Further, if it is a case that the synchronization starting timing is the closing timing of a registration operation or the closing time of a shop, then a part of or all of the local dictionary data stored in the auxiliary storage device 254 is copied to the RAM 203, if needed, after the POS terminal 2 is started so that such copied data is applied to the determination processing of the commodity category by the object recognition unit 200. If the local dictionary data is stored beforehand in an auxiliary storage device which is provided to the object recognition unit 200, then the local dictionary data stored in the RAM 253 may be copied to the auxiliary storage device by the CPU 251 and the CPU 201 shortly after the completion of the push-synchronization processing.

The CPU 101 proceeds to ACT Sa6 from ACT Sa5 shown in FIG. 4 when the push-synchronization processing is completed in the aforementioned manner.

In ACT Sa6, the CPU 101 confirms whether or not there is one or more unselected terminals. If the result of the determination is ‘Yes’ because there is one or more unselected terminals, the CPU 251 repeats the processing of ACT Sa4 and ACT Sa5. That is, the CPU 251 successively carries out the push-synchronization processing on the unselected terminals as an object terminal. Then, if the result of the determination in ACT Sa6 is ‘No’ because the push-synchronization processing is carried out to all the plurality of POS terminals 2 and therefore there is no unselected terminal, then the CPU 101 completes the dictionary synchronization processing.

Thus, in accordance with the POS system of the present embodiment, the dictionary server 1 distributes the master dictionary data stored in the auxiliary storage device 104 to a plurality of POS terminals 2, respectively. The plurality of POS terminals 2 respectively update the local dictionary data stored in the RAM 203 for reference to the determination of a commodity category according to the master dictionary data distributed by the dictionary server 1. Thus, by updating the master dictionary data stored in the auxiliary storage device 104, the dictionary server 1 can reflect the update to the local dictionary data managed by each of the plurality of POS terminals 2. In this way, the update of the local dictionary data, in which changes in the commodities sold in the seasons and the individual difference in appearances of the commodities of the same commodity category is taken into consideration, is carried out by the dictionary server 1, thus, the update can be reflected to the local dictionary data of each of the plurality of POS terminals. Consequentially, the dictionary data used by the plurality of object recognition units 200 can be effectively updated without carrying out the work for updating a dictionary data respectively in each of the POS terminals 2, that is, the object recognition units 200.

Further, in the POS system of the present embodiment, since the master dictionary data is updated to reflect the learning result in the local dictionary data, the update work of the dictionary data in each POS terminal 2 can be executed simultaneously as that of the master dictionary data. Therefore, the time and labor on the updating the master dictionary data can be reduced.

Further, the POS system of the present embodiment executes the learning on the dictionary data for one commodity transaction. Therefore, it is especially effective in a case that an object recognition scanner system in which the data of each commodity code contained in the local dictionary is updated one by one at any time is applied.

In this embodiment, the following modifications can be possible.

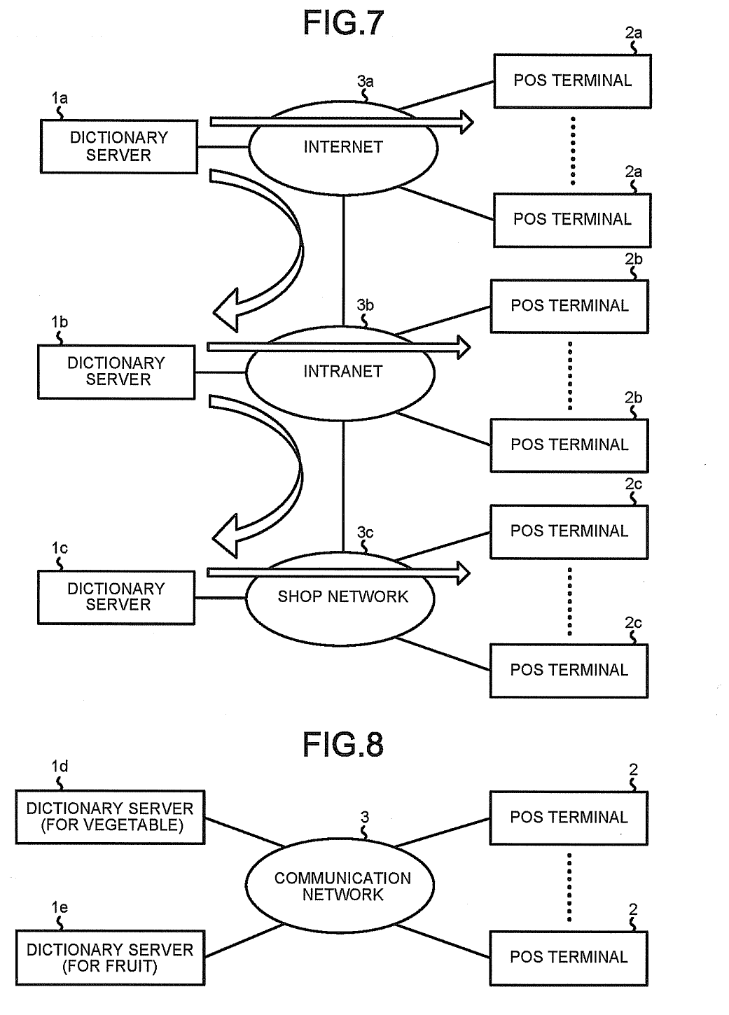

FIG. 7 is a diagram illustrating an example of a modification of the POS system.

The POS system shown in FIG. 7 includes dictionary servers 1a, 1b and 1c. The dictionary server 1a is connected with the Internet 3a, the dictionary server 1b is connected with an intranet 3b, and the dictionary server 1c is connected with a shop network 3c, respectively. Further, the POS system shown in FIG. 7 includes a plurality of POS terminals 2a connected with the Internet 3a, a plurality of POS terminals 2b connected with the Intranet 3b and a plurality of POS terminals 2c connected with the shop network 3c.

The dictionary server 1a distributes the dictionary data kept in the dictionary server 1a to the plurality of POS terminals 2a via the Internet 3a and sends to the dictionary server 1b via the Internet 3a and the intranet 3b, as well.

The dictionary server 1b distributes the dictionary data sent from the dictionary server 1a or the dictionary data obtained by updating the dictionary data kept in the dictionary server 1b according to the dictionary data sent from the dictionary server 1a to the plurality of POS terminals 2b via the Intranet 3b and sends the same to the dictionary server 1c via the Intranet 3b and the shop network 3c, as well.

The dictionary server is distributes the dictionary data sent from the dictionary server 1b or the dictionary data obtained by updating the dictionary data kept in the dictionary server 1c according to the dictionary data sent from the dictionary server 1b to the plurality of POS terminals 2c via the shop network 3c.

Thus, the distribution of the dictionary data by the dictionary server to the POS terminals may be shared by at least two dictionary servers provided.

Even in a POS system in which an object recognition scanner equivalent to the object recognition unit 200 or an object recognition scanner including the object recognition unit 200 is independent from POS terminals, such modification described above can be applied as similar to the aforementioned embodiment.

The function of the object recognition unit described in the embodiment above may be carried on a handy terminal, a weighing scale or a label printer.

FIG. 8 is a diagram illustrating another example of a modification of a POS system.

The POS system shown in FIG. 8 includes dictionary servers 1d and 1e and a plurality of POS terminals 2. The dictionary servers 1d and 1e can communicate with the plurality of POS terminals 2 via the communication network 3.

The dictionary server 1d keeps a dictionary data in which commodity categories relating to vegetables (hereinafter referred to as a dictionary data for vegetable) are described. The dictionary server 1e keeps a dictionary data in which commodity categories relating to fruits (hereinafter referred to as a dictionary data for fruit) are described. The dictionary server 1d distributes the dictionary data for vegetable to the plurality of POS terminals 2, and the dictionary server 1e distributes the dictionary data for fruit to the plurality of POS terminals 2. Each POS terminal 2 updates the descriptions for the commodity category relating to ‘vegetable’ in the dictionary data kept by itself according to the dictionary data for vegetable, and the descriptions for the commodity category relating to ‘fruit’ in the dictionary data kept by itself according to the dictionary data for fruit.

In this way, a plurality of dictionary data, each of which belongs to one of a plurality of groups, may be prepared independently, and managed by each dictionary server.

Besides, in this case, a POS terminal or an object recognition scanner is installed in a vegetable market, for example, to update the dictionary data for vegetable managed by the dictionary server 1d, using the result of the determination of the commodity categories for the commodities sold in the vegetable market by the POS terminal or the object recognition scanner, and a POS terminal or an object recognition scanner is installed in a fruit market, for example, to update the dictionary data for fruit managed by the dictionary server 1e, using the result of the determination of the commodity categories for the commodities sold in the fruit market by the POS terminal or the object recognition scanner, and whereby each dictionary data can be updated quickly to be matched with the supply of commodities in each market without waiting for the result of the learning in each shop.

The master dictionary data may be updated with any method. For example, the master dictionary data may be updated in such a manner that the feature amount acquired by an object recognition scanner for learning or a dedicated image analyzer is included in the master dictionary data. Moreover, if the master dictionary data is updated with such a different method, it is not indispensable that the synchronization processing (hereinafter referred to as an upward-synchronization processing) for reflecting the learning result of the POS terminal 2 to the master dictionary data is performed.

The upward-synchronization processing may be executed as a push-synchronization processing. That is, the POS terminal 2 may actively start the upward-synchronization processing in a spare time.

The upward-synchronization processing may be executed for each of the plurality of POS terminals 2 at different timings.

The synchronization processing for synchronizing the local dictionary data with the master dictionary data (hereinafter referred to as a downward-synchronization processing) may also be executed as a pull-synchronization processing. That is, the POS terminal 2 may actively start the downward-synchronization processing in a spare time.

The downward-synchronization processing may be executed for each of the plurality of POS terminals 2 at different timings.

The upward-synchronization processing and the downward-synchronization processing may be executed at unrelated timings, as well.

The dictionary server 1 may be provided with a function for updating the master dictionary data so as to include a feature amount extracted from the image data.

All the master dictionary data may be distributed to the POS terminal 2 to replace all the local dictionary data with the master dictionary data distributed.

The dictionary data may use information in which time is made to an integer, such as, seconds accumulated from a past moment, instead of information of the update time. The processing for comparing update timings becomes a simple processing.

The synchronization processing relating to each of the plurality of POS terminals 2 may be carried out in parallel. In this case, various commands received or transmitted between the dictionary server 1 and the POS terminals 2 include the recognition information of the POS terminals 2, and the dictionary server 1 executes procedures with each of the plurality of POS terminals 2 asynchronously.

By changing the determination condition in ACT Sc2 shown in FIG. 5 and ACT Sd3 shown in FIG. 6 to a condition in which ‘TCs is different from TCd’, it becomes possible that much more learning result of each of the plurality of POS terminals 2 can be used to update the dictionary data.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing system, comprising:
a plurality of information processing apparatus and a dictionary server, wherein
each of the information processing apparatus includes:
a local storage device configured to store a local dictionary data which describes a feature amount relating to the appearance of a commodity belonging to one of a plurality of commodity categories; and
a determination module configured to determine the category of the commodity shown by an image by comparing the feature amount extracted from the image showing the appearance of the commodity with the feature amount described in the local dictionary data,
wherein
the dictionary server includes:
a master storage device configured to store a master dictionary data which describes the feature amount relating to the appearance of a commodity belonging to one of the plurality of commodity categories;
a master update module configured to update the master dictionary data; and
a master transmitting module configured to transmit the master dictionary data updated by the master update module to the information processing apparatus, and
wherein
each of the information processing apparatus further includes:
a local update module configured to update the local dictionary data according to the master dictionary data transmitted by the master transmitting module.

2. The information processing system according to claim 1, wherein
the information processing apparatus further includes:
a learning module configured to update the local dictionary data, using the feature amount extracted from the image, and
a local transmitting module configured to transmit the local dictionary data updated by the learning module to the dictionary server, and
wherein
the master update module updates the master dictionary data, using the local dictionary data transmitted by the local transmitting module.

3. The information processing system according to claim 2, wherein
the master dictionary data and the local dictionary data include a plurality of data records in which a commodity code for identifying the commodity categories is associated with the feature amount,
the master update module updates the master dictionary table by updating the data records,
the master transmitting module transmits the data record updated by the master update module to the information processing apparatus and
the local update module updates, according to the feature amount included in the data record transmitted by the transmitting module within the data records contained in the local dictionary data, the feature amount included in a data record including the commodity code the same as that contained in the data record transmitted by the transmitting module.

4. An information processing apparatus, which is capable of communicating with a dictionary server including a master storage device configured to store a master dictionary data which describes a feature amount relating to the appearance of a commodity belonging to one of a plurality of commodity categories, a master update module configured to update the master dictionary data, and a master transmitting module configured to transmit the master dictionary data updated by the master update module, comprising:
a local storage device configured to store a local dictionary data which describes a feature amount relating to the appearance of a commodity belonging to one of the plurality of commodity categories;
a determination module configured to determine the category of the commodity shown by an image by comparing the feature amount extracted from the image showing the appearance of the commodity with the feature amount described in the local dictionary data, and
a local update module configured to update the local dictionary data according to the master dictionary data transmitted by the transmitting module.

5. The information processing apparatus according to claim 4, further comprising:
a learning module configured to update the local dictionary data, using the feature amount extracted from the image, and
a local transmitting module configured to transmit the local dictionary data updated by the learning module to the dictionary server.

6. The information processing apparatus according to claim 5, further comprising:
a third confirmation module configured to confirm whether or not the master dictionary data is different form the local dictionary data; and
a fourth confirmation module configured to confirm whether or not the data records relating to the same commodity code contained in the master dictionary data and the local dictionary data are different from each other if the third confirmation module determines that the master dictionary data is different from the local dictionary data,
wherein
the local transmitting module transmits a data record which is determined by the second confirmation module such that it is not different from the data record contained in the master dictionary data within the data records contained in the local dictionary data.

7. The information processing apparatus according to claim 6, wherein
the master dictionary data includes a fourth timing information representing the update timing of the master dictionary data,
the local dictionary data includes a fifth timing information representing the update timing of the local dictionary data and a sixth timing information representing each update timing of the data records contained in the local dictionary data,
the third confirmation module confirms whether or not the master dictionary data is different from the local dictionary data by comparing the fourth timing information with the fifth timing information, and
the fourth confirmation module confirms whether or not the data records relating to the same commodity code contained in the master dictionary data and the local dictionary data are different from each other by comparing the fourth timing information with the sixth timing information.

8. The information processing apparatus according to claim 4, wherein
the master dictionary data and the local dictionary data contain a plurality of data records in which a commodity code for identifying commodity category is associated with the feature amount;
the dictionary server updates the master dictionary table by updating the data records and transmits the updated data records to the information processing apparatus; and
the local update module updates, according to the feature amount contained in the data record transmitted by the dictionary server within the data records contained in the local dictionary data, the feature amount contained in the data record containing the commodity code the same as that contained in the data record transmitted by the dictionary server.

9. A method for updating data by a dictionary server, which is capable of communicating with a plurality of information processing apparatus including a local storage device configured to store a local dictionary data which describes a feature amount relating to the appearance of a commodity belonging to one of a plurality of commodity categories, a determination module configured to determine the category of the commodity shown by an image by comparing the feature amount extracted from the image showing the appearance of the commodity with the feature amount described in the local dictionary data, and a local update module configured to update the local dictionary data according to a master dictionary data, including:
storing a master dictionary data which describes the feature amount relating to the appearance of a commodity belonging to one of a plurality of commodity categories;
updating the master dictionary data; and
transmitting the updated master dictionary data so that the local dictionary data is updated by the updated master dictionary data.
